(19) United States
(12) Patent Application Publication
(10) Pub. No.: US 2006/0180009 A1
(43) Pub. Date: Aug. 17, 2006

(54) Electronic musical apparatus

(75) Inventor: Takeshi Komano, Iwata-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/354,630

(22) Filed: Feb. 14, 2006

(30) Foreign Application Priority Data
Feb. 16, 2005 (JP) 2005-039672

(51) Int. Cl. G10H 7/00

(52) U.S. Cl. 84/645

(57) ABSTRACT

In an electronic musical apparatus having a function of synthesizing audio data basing on MIDI data to generate audio data corresponding to the MIDI data and recording the audio data, when the audio data is recorded, data of a protection flag indicating whether or not to inhibit copy and movement of the audio data is generated basing on contents of the MIDI data used for generation of the audio data, and recorded together with the audio data, and when the contents of the protection flag is “1” indicating inhibition of copy and movement, copy and movement of the recorded audio data are inhibited.

### BACKGROUND OF THE INVENTION

1. Field of the Invention

The invention relates to an electronic musical apparatus having a sound recording function of recording audio data generated basing on MIDI (Musical Instruments Digital Interface) data.

2. Description of the Related Art

Conventionally, it is known that an electronic musical apparatus handling MIDI data is provided with a function of generating waveform data (audio data) in an audio format by a sound source basing on the MIDI data and recording the data on a recording medium.

For example, JP 2003-255939 A discloses an apparatus that generates audio waveform data by a software sound source basing on sound material data in the MIDI format downloaded from a sound material providing site and records the generated audio waveform data.

Further, JP 2002-116757 A discloses an apparatus that generates audio data by carrying out processing of synthesizing musical sounds by a sound source basing on the MIDI data, and compresses the audio data and then records the resultant data on a recording medium with data of text, image, and so on associated therewith so as to enable karaoke based on general MIDI data to be performed even by an audio device having no MIDI sound source.

Data expressing a musical composition is covered by copyright and related rights, and therefore when such data is handled, the rights often need to be protected according to intention of the right holder. This also applies to the MIDI data and the audio waveform data generated basing on the MIDI data.

However, the apparatus disclosed in each of the above publications has no system for restricting use of the MIDI data and the audio waveform data and accordingly allows the data to be freely copied and moved, thus failing to sufficiently protect the right such as the copyright and so on.

It should be noted that JP 2002-116757 A discloses that the audio data is recorded with copyright information added thereto but has no description of use restriction of the data based on the information.

There is a known technique usable for right protection as described above disclosed, for example, in JP 2003-58150 A, which provides a flag indicating whether the copyright protection is necessary or not in correspondence with the MIDI musical composition data, determines whether the copyright protection is necessary or not for the MIDI musical composition data basing on the flag, restricts output to the external part of the apparatus of the MIDI musical composition data requiring copyright protection, and permits output to the external part of the apparatus of the MIDI musical composition data requiring no copyright protection.

### SUMMARY OF THE INVENTION

The technique disclosed in JP 2003-58150 A, however, has a problem. The problem is that even if copy and output of the MIDI musical composition data requiring copyright protection are inhibited, once audio data is generated by automatic performance basing on the data and then recorded, the recorded audio data can be freely outputted and copied for use.

Though the audio data outputted in a digital form is the data converted into a different format from the original MIDI data, the audio data has not deteriorated in quality as compared to the original MIDI data. Hence, there is a demand even on prevention of copy and output of the audio data generated basing on the MIDI data for a musical composition whose use is restricted for copyright protection or the like.

The invention has been developed to meet the demand and has an object to make it possible, in an electronic musical apparatus having a sound recording function of recording audio data generated basing on MIDI data, to restrict copy and movement of the audio data generated basing on the MIDI data if it requires restriction.

To attain the above object, the invention is an electronic musical apparatus including: an audio data generator for generating audio data corresponding to MIDI data basing on the MIDI data; a memory; a first controller for generating, when the audio data generated by the audio data generator is stored in the memory, data of a protection flag indicating whether or not to inhibit copy and movement of the audio data basing on contents of the MIDI data used for generation of the audio data, and storing the data of the protection flag together with the audio data in the memory; and a second controller for permitting or inhibiting copy and movement of the audio data stored in the memory basing on contents of the protection flag.

It is preferable that in such an electronic musical apparatus, the first controller stores the audio data and the protection flag in the memory in a restriction format, the restriction format preventing a common device from normally reading the audio data and protection flag.

Further, it is preferable to include a converter for converting the audio data stored in the memory in the restriction format to a predetermined format, the predetermined format allowing the common device to normally read the audio data; and a third controller for inhibiting conversion by the converter for the audio data whose protection flag indicates inhibition of copy and movement thereof.

Further, it is preferable that the audio data generator includes a generator for generating one piece of audio data corresponding to a plurality of pieces of MIDI musical composition data basing on the plurality of pieces of MIDI musical composition data, and that the first controller makes the data of the protection flag data indicating inhibition of copy and movement of the audio data for the audio data corresponding to the plurality of pieces of MIDI musical composition data, when at least one piece of the corresponding MIDI musical composition data contains information that use of the data is restricted.

Furthermore, a program of the invention is a computer program containing program instructions executable by a computer which controls an electronic musical apparatus, and causing the computer to execute: an audio data generating process of generating audio data corresponding to MIDI data basing on the MIDI data; a first controlling process of generating, when the audio data generated in the audio data generating process is stored in a memory, data of a protection flag indicating whether or not to inhibit copy and movement of the audio data basing on contents of the MIDI data used for generation of the audio data, and storing the data of the protection flag together with the audio data in the memory; and a second controlling process of permitting or inhibiting copy and movement of the audio data stored in the memory basing on contents of the protection flag.

The above and other objects, features and advantages of the invention will be apparent from the following detailed description which is to be read in conjunction with the accompanying drawings.

### BRIEF DESCRIPTION OF THE DRAWINGS

FIG. 1 is a block diagram showing a configuration of an electronic 5 musical instrument being a first embodiment of an electronic musical apparatus of the invention;

FIG. 2 is an illustration showing a configuration of data to be stored in a ROM of the electronic musical instrument shown in FIG. 1;

FIG. 3 is an illustration showing a configuration of data to be stored in an HDD of the same;

FIG. 4 is a diagram showing a configuration of a portion relating to generation and recording of audio data in the electronic musical instrument shown in FIG. 1 together with a flow of the data;

FIG. 5 is a flowchart showing a portion of main processing executed by a CPU of the electronic musical instrument;

FIG. 6 is a flowchart showing the processing subsequent thereto;

FIG. 7 is a flowchart showing the processing subsequent thereto;

FIG. 8 is an illustration showing a portion of controls provided on a control panel of the electronic musical instrument shown in FIG. 1;

FIG. 9 is an illustration showing an example of a performance list screen to be displayed by a display device of the same;

FIG. 10 is a flowchart of processing relating to an audio file list screen activated in step S23 in FIG. 6;

FIG. 11 is a flowchart of processing relating to a status information screen shown in step S43 in FIG. 10;

FIG. 12 is a flowchart of processing relating to a performance list reference screen shown in step S67 in FIG. 11;

FIG. 13 is an illustration showing an example of an audio file list screen to be displayed by the display device of the electronic musical instrument shown in FIG. 1;

FIG. 14 is an illustration showing an example of a status information screen of the same; and

FIG. 15 is an illustration showing an example of a performance list reference screen of the same.

### DETAILED DESCRIPTION OF THE PREFERRED EMBODIMENTS

Hereinafter, preferred embodiments for carrying out the invention will be concretely described with reference to the drawings.

A configuration of an electronic musical instrument being an embodiment of an electronic musical apparatus of the invention will be described first using FIG. 1. FIG. 1 is a block diagram showing the configuration of the electronic musical instrument.

As shown in FIG. 1, an electronic musical instrument 10 includes a CPU 11, a ROM 12, a RAM 13, a timer 14, an external device I/F (interface) 15, a hard disk drive (HDD) 16, detection circuits 17 and 18, a display circuit 19, a sound source 20, and a signal processor 24, which are connected by a system bus 27.

The electronic musical instrument 10 further includes performance controls 21 and panel controls 22 respectively connected to the detection circuits 17 and 18 and a display device 23 connected to the display circuit 19 as well as an audio input 25 for inputting audio signals into the signal processor 24 and a speaker 26 for outputting the audio signals processed by the signal processor 24.

The CPU 11, which is a controller that comprehensively controls the electronic musical instrument 10, can execute a required control program stored in the ROM 12 to carry out control operations such as control of inputting/outputting data to/from the HDD 16, detection of operation contents of the performance controls 21 and the panel controls 22 via the detection circuits 17 and 18, control of display by the display device 23 via the display circuit 19, control of communication via the external device I/F 15, control of audio data generation in the sound source 20, control of audio signal processing in the signal processor 24, and so on.

The ROM 12 is a memory that stores the control program executed by the CPU 11, data that does not need to be changed, and so on. It is also conceivable that the ROM 12 is constituted of a rewritable non-volatile memory such as a flash memory or the like to allow updating of data. Further, it is possible to store, in the ROM 12, fixed data of later-described MIDI musical composition data for automatic performance.

The RAM 13 is a memory that is used as a work memory of the CPU 11, stores values of parameters to be temporarily used, and so on.

The timer 14 is a time keeper that generates time keeping signals for managing timing of generation of MIDI events from the MIDI musical composition data in the CPU 11, generation of the audio data in the sound source 20 basing on the MIDI events, the audio signal processing in the signal processor 24, write and read of the audio data to/from the HDD 16, and so on. The function of the timer 14 may be provided in the CPU 11.

The external device I/F 15 is an interface connected to the network such as a LAN (local area network) or the like to communicate with external devices such as a PC (personal computer) and the like. The external device I/F 15 can be constituted of an interface under, for example, Ethernet (registered trademark) standard. It is also conceivable to configure the external device I/F 15 such that it uses an interface under USB (Universal Serial Bus) standard, IEEE 1394 (Institute of Electrical and Electronic Engineers 1394) standard, or RS232C (Recommended Standard 232 version C) standard or the like, so as to transmit/receive the MIDI data to/from an external device in compatible with the MIDI or to allow an external memory to be connected thereto.

The HDD 16 is a memory that stores MIDI musical composition data to be used for automatic performance, audio data obtained by the signal processor 24 processing the audio signals generated by the sound source 20 or inputted from the audio input 25, the program executed by the CPU 11, and so on. Note that the MIDI musical composition data may contain data generated in accordance with operation of the performance controls 21, data received from the external device via the external device I/F 15, and so on in addition to those previously stored in the HDD 16.

The detection circuits 17 and 18 are circuits for detecting the contents of operation performed on the performance controls 21 and panel controls 22, respectively, and sending signals according to the contents to the CPU 11. The performance controls 21 are a controls for performance such as a keyboard or the like, and the panel controls 22 are controls composed of keys, buttons, dials, sliders, and the like, for accepting operations to the electronic musical instrument 10 from a user. Note that the display device 23 and the panel controls 22 can be integrally formed by stacking a touch panel on an LCD or the like.

The display circuit 19 is a circuit for controlling display by the display device 23 in accordance with an instruction from the CPU 11. The display device 23 is a display composed of a liquid crystal display (LCD), a light emitting diode (LED) lamp, or the like, for displaying the operation state and the setting contents of the electronic musical instrument 10 or a message to the user, or a graphical user interface (GUI) for accepting instructions from the user or the like.

The sound source 20 is an audio data generator for generating audio data being digital audio signals by a plurality of sound generation channels depending on the MIDI event received from the CPU 11. The generated audio data is then inputted to the signal processor 24 and provided to the signal processing in the signal processor 24.

The signal processor 24 is a signal processor that carries out signal processing such as mixing or the like in accordance with set processing parameters, for the audio data inputted from the sound source 20 or the audio input 25 or the audio data read from the HDD 16 and played. The audio data which has been processed by the signal processor 24 is not only used to output sound based on the audio data through the speaker 26 but can also be transferred to the HDD 16 so that the sound is recorded on the HDD 16.

The electronic musical instrument 10 having the above-described configuration has a function of causing the sound source 20 to generate audio data basing on the MIDI musical composition data being the MIDI data stored in the ROM 12 or the HDD 16 or on the MIDI event being the MIDI data generated by the CPU 11 according to the performance operation on the performance controls 21, and a function of sound recording by recording the audio data processed by the signal processor 24 onto the HDD 16, so that the functions can be combined to record, onto the HDD 16, the audio data relating to the musical composition being the contents of the above-described MIDI musical composition data or the musical composition performed by the performance controls 21.

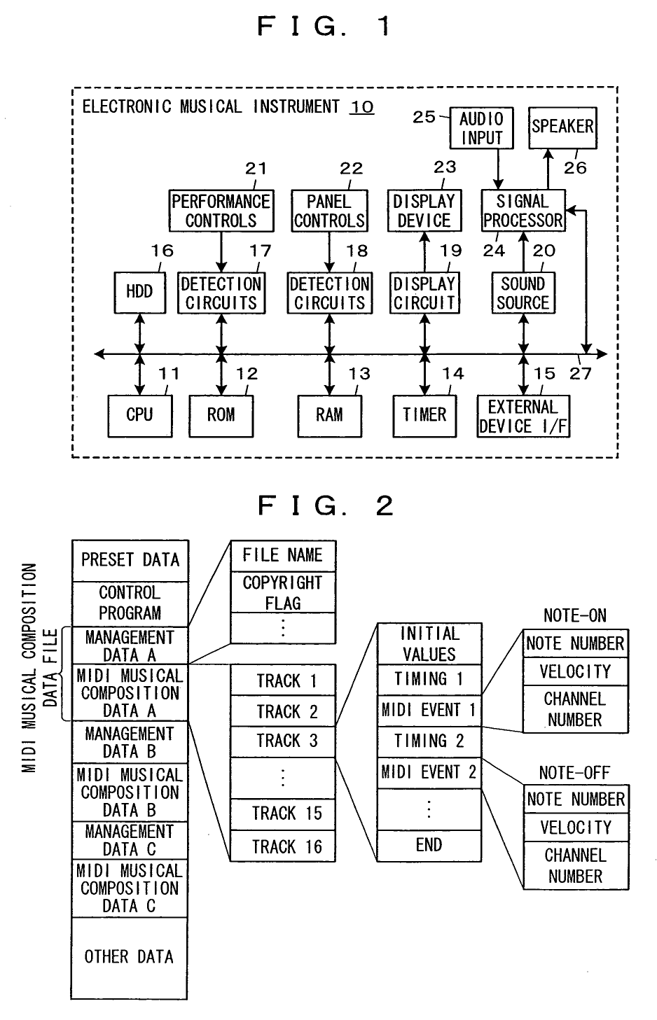

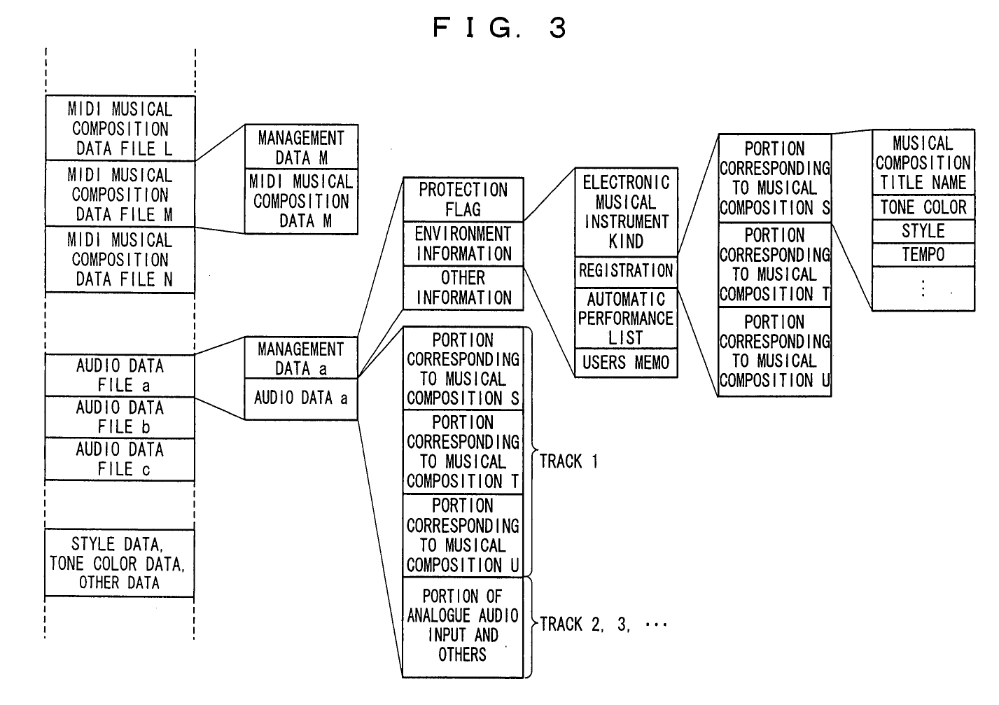

Next, the configuration of the data relating to the functions will be described using FIG. 2 and FIG. 3.

The configuration of the data to be stored in the ROM 12 is shown in FIG. 2.

As shown in this drawing, the ROM 12 stores the MIDI musical composition data in which contents of one musical composition are recorded in the MIDI format, in addition to preset data being fixed data to be used for initial setting and the control program used by the CPU 11 to control the electronic musical instrument 10. Each piece of MIDI musical composition data is stored in a manner to correspond to management data, and these kinds of data are combined into one set to form one MIDI musical composition data file. Note that the MIDI musical composition data files to be stored in the ROM 12 are basically fixed ones basically provided by the manufacturer.

The MIDI musical composition data is composed of data representing performance contents of 16 tracks, and data of each track contains initial values representing setting contents such as a performance style, tone color, and so on, and data indicating contents of MIDI events to be generated and their timings. The MIDI event, for example, in the case of note-on or note-off, contains data of a note number indicating a tone pitch of sound to be generated, a velocity indicating strength, and a channel number indicating a channel to be used for sound generation.

When the audio data is generated basing on the MIDI musical composition data, the CPU 11 generates a designated MIDI event at a designated timing for necessary tracks and sends it to the sound source 20 so that the sound source 20 carries out automatic performance in which the audio data is generated basing on the received MIDI event and the setting contents such as the tone color, the style and so on.

The management data contains information on a file name of the MIDI musical composition data file and a copyright flag being information indicating whether or not to restrict use of the MIDI musical composition data. As the copyright flag, “1” is registered if the use of the musical composition data is restricted for copyright protection, while “0” is registered if the copyright protection is not required.

Note that rather than the information indicating the presence or absence of right protection such as a copyright flag, other information may be used as the information indicating the presence or absence of restriction of use.

Next, the configuration of data to be stored in the HDD 16 is shown in FIG. 3.

As shown in the drawing, the HDD 16 stores the MIDI musical composition data, the audio data, style data, tone color data, and so on. Among these kinds of data, the MIDI musical composition data can be downloaded from the external part, or generated basing on the performance operation by the performance controls 21 and then stored. The configuration of the data, however, is not different from that in the ROM 12 shown in FIG. 2, and therefore detailed illustration and description thereof will be omitted.

The audio data is data generated by the sound source 20 or inputted from the audio input 25 and recorded, and management data is added to the audio data to form one audio data file. The audio data file is created and recorded in a restriction format which prevents a common device from normally reading it, at the time of recording the audio data, and thereafter data whose copy and movement are not inhibited can be converted to audio data in WAV format or the like (hereinafter, referred also to as a “general format”), which can be normally read by a common device. Conceivable restriction formats include a format under the manufacturer original standard, a commonly used format in which, however, data is encrypted and can be decoded only by a specific device, and so on. A data file may also be employed which is made by slightly modifying the general audio data format or the file structure to prevent a common device from normally reading it.

In the electronic musical instrument 10, the audio data can be dividedly recorded on a plurality of tracks, and in this embodiment the audio data generated by the sound source 20 is recorded on a track 1 and the audio data inputted from the audio input 25 is recorded on a track 2 or subsequent thereto. When the audio data which the sound source 20 generates by automatic performance based on a plurality of pieces of the MIDI musical composition data (relating to a plurality of musical compositions) is recorded, portions of the audio data corresponding to each of the musical compositions can be dividedly recorded.

The management data corresponding to the audio data also contains a protection flag being data indicating whether or not to inhibit copy and movement of the audio data and environment information being data indicating generation environment of the audio data. Conceivable contents of the environment information include, for example, an electronic musical instrument kind indicating the kind of the electronic musical instrument which has generated the audio data; registration indicating contents of setting made in each section of the electronic musical instrument 10 including the sound source 20 at the time of generating the audio data; an automatic performance list indicating on which MIDI musical composition data the audio data has been generated by automatic performance based; and users memo which the user can arbitrarily create, but it is not essential to contain all of the above.

Conceivable contents of registration include a musical composition title name, tone color, style, tempo, and so on. When the audio data is generated from automatic performance based on a plurality of pieces of the MIDI musical composition data, the contents of setting are possibly different for each piece of musical composition data, and therefore the registration can also be stored for each musical composition.

Other data in the management data can be setting of recording time, punch-in, punch-out, and so on.

The style data and the tone color data stored in the HDD 16 are data on performance style and data on tone color which are set according to the contents of the MIDI musical composition data or manually set into the sound source 20, when the sound source 20 generates the audio data. These kinds of data can also be set according to the registration contained in the management data.

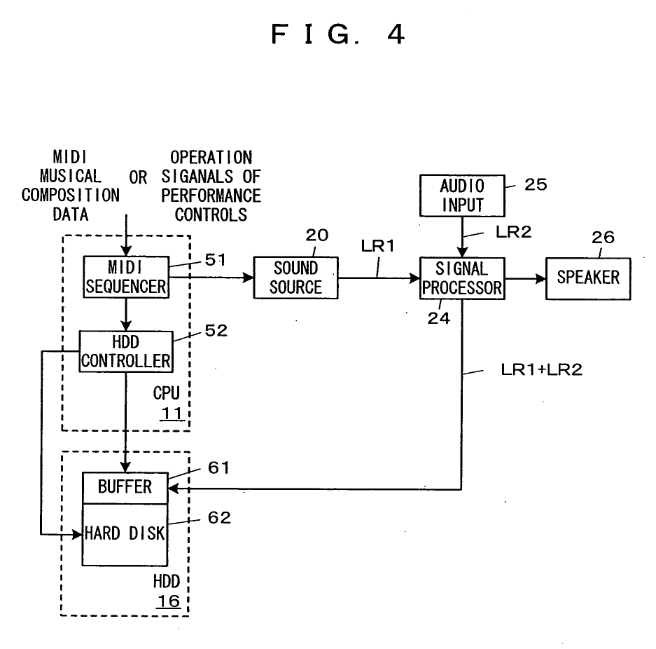

Next, the configuration of a portion relating to generation and recording of the audio data of the electronic musical instrument 10 is shown with flow of the data in FIG. 4.

When the automatic performance is carried out basing on the MIDI musical composition data in the electronic musical instrument 10, the CPU 11 obtains the MIDI musical composition data from the ROM 12 and the HDD 16, and functions as a MIDI sequencer 51 to generate data of a MIDI event designated at the designated timing in accordance with the tempo designated by the MIDI musical composition data and send the data to the sound source 20. The MIDI musical composition data may be obtained from an external device. When the generation of sound is carried out in accordance with the performance operation by the user, the MIDI sequencer 51 similarly generates data of a MIDI event required for the sound generation in accordance with the operation of the performance controls 21 and sends the data to the sound source 20.

In both cases, upon receipt of the MIDI event, the sound source 20 generates audio data basing on the event, the set performance style, tone color, and so on, and inputs the data into the signal processor 24 as audio data LR1. The audio signal inputted from the audio input 25 is converted to digital audio data and also inputted into the signal processor 24 as audio data LR2.

When outputted as sound, these kinds of audio data are subjected to appropriate signal processing such as mixing, equalizing, or the like in the signal processor 24, converted to analog audio signals, and then outputted to the speaker 26 for sound generation. When the audio data is recorded on the HDD 16, the signal processor 24 sends the audio data LR1 and LR2 to a buffer 61 in the HDD 16 to provide the data for recording operation onto the HDD 16. Although the audio data LR1 and LR2 are sent as individual data to be recordable as data for separate tracks in this embodiment, it is also possible to send the data after mixing.

The CPU 11 functions as an HDD controller 52 to control operations of the buffer 61 and a hard disk 62 so that the buffer 61 starts accumulation of audio data in accordance with -an instruction to start sound recording and writes the data into the hard disk 62 every time the audio data in a predetermined size is accumulated.

The HDD controller 52 also carries out management of a file allocation table (FAT) in the HDD 16. When an instruction to end the sound recording is given, the HDD controller 52 obtains, from the MIDI sequencer 51, the copyright flag of the MIDI musical composition data which has been used for generation of the audio data and obtains, from other sections, information on the electronic musical instrument kind, registration, automatic performance list (only in the case of automatic performance), and so on, generates management data corresponding to the recorded audio data basing on the information, forms a set of the management data and the audio data, and records the set of data onto the hard disk 62 as an audio data file.

In particular, the protection flag, in the case of automatic performance, is generated basing on the contents of the copyright flag of the MIDI musical composition data which has been used for the automatic performance, such that if use restriction of the musical composition data is set for at least one piece of the MIDI musical composition data, the protection flag relating to the recorded audio data also has a value (“1” in this embodiment) representing inhibition of copy and movement of the audio data to restrict use of the data. This is because it is conceivable that if even a portion of data require use restriction, use of the whole data should often be restricted.

It is preferable that even when the performance contents by the performance controls 21 are recorded, the value of the protection flag can be set in response to a user instruction. This is because the user may desire restriction of use of the data even in this case.

The data on the electronic musical instrument kind, registration, and automatic performance list can be generated basing on the contents currently set in the electronic musical instrument 10. As for the registration, it is also possible to obtain the information on the registration contained in the initial value of each track of the MIDI musical composition data which has been used for automatic performance and to use its contents.

As for the recording of the data onto the HDD 16, the audio data may be recorded in a general format during sound recording. However, when the audio data file is created, the data is generated and recorded in the restriction format. The reason why such a format is used is to prevent free use of the data whose copy and movement need to be restricted for the reason of copyright protection or the like even if the data is read to the external part.

Incidentally, the file name may be automatically generated or determined in accordance with the designation by the user.

The audio data contained in the audio data file created as above is the audio data corresponding to the MIDI musical composition data which has been used for the automatic performance or a series of MIDI events generated by the CPU 11 in accordance with the operation of the performance controls 21.

Next, processing executed by the CPU 11 of the electronic musical instrument 10 to realize various functions will be described mainly for portions relating to characteristics of this embodiment.

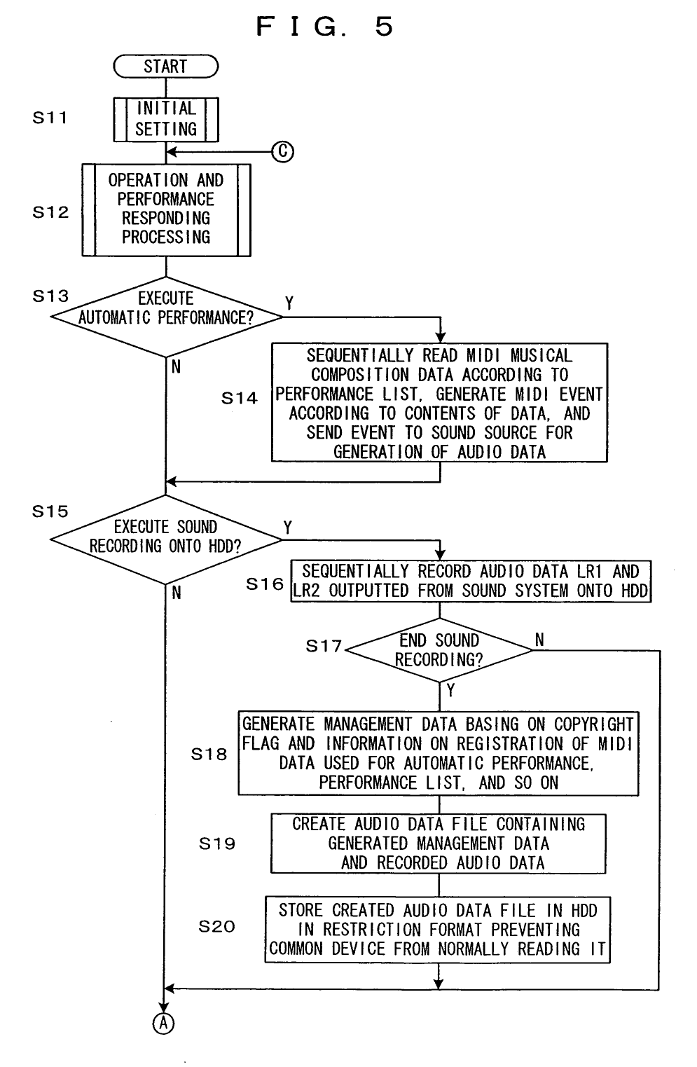

First, a flowchart of main processing executed by the CPU 11 of the electronic musical instrument 10 is shown in FIG. 5 to FIG. 7. Although the processing will be described below following the flow, it is not always necessary to inhibit progress of the flow until previous processing is completed, and processing in a plurality of steps can be executed in parallel to the extent possible by using an event driven-type program or the like.

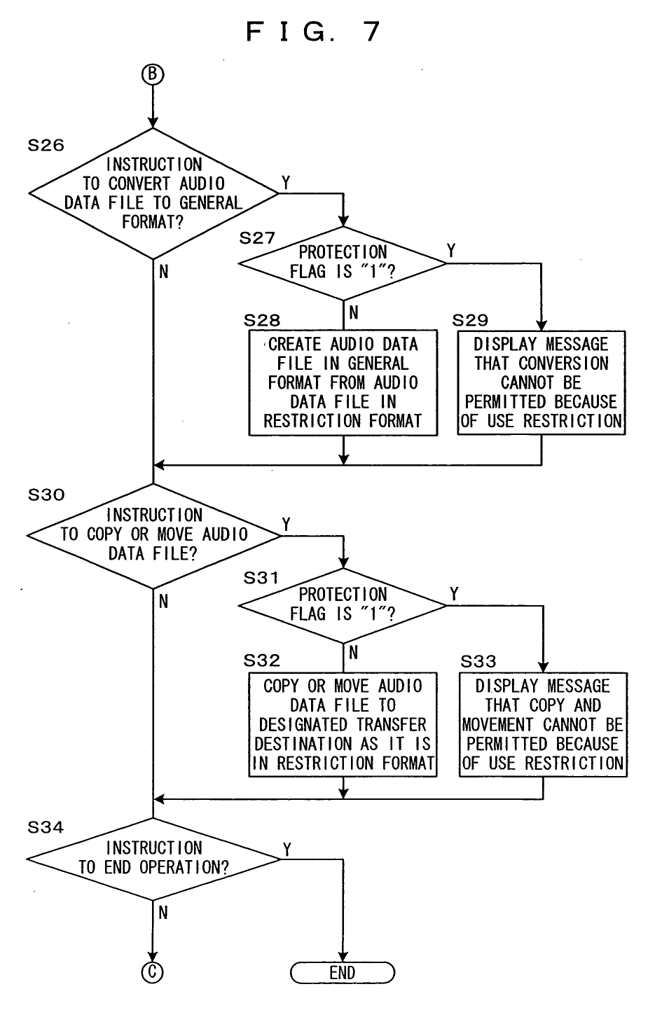

Upon power-on of the electronic musical instrument 10, the CPU 11 starts the processing shown in the flowchart in FIG. 5. The CPU 11 first carries out required initial setting processing such as setting the values of the register, flag, parameter, and so on to initial values, and initialization of a communication I/F (S11), and then repeats processing from step S12 to step S34 in FIG. 7 until the power is tuned off or the operation of the electronic musical instrument 10 ends.

In step S12, the CPU 11 carries out operation and performance responding processing. This processing is processing of setting the value of the parameter according to the operation of the panel controls 22, processing for sound generation according to the operation of the performance controls 21, processing of communication with an external device, and so on.

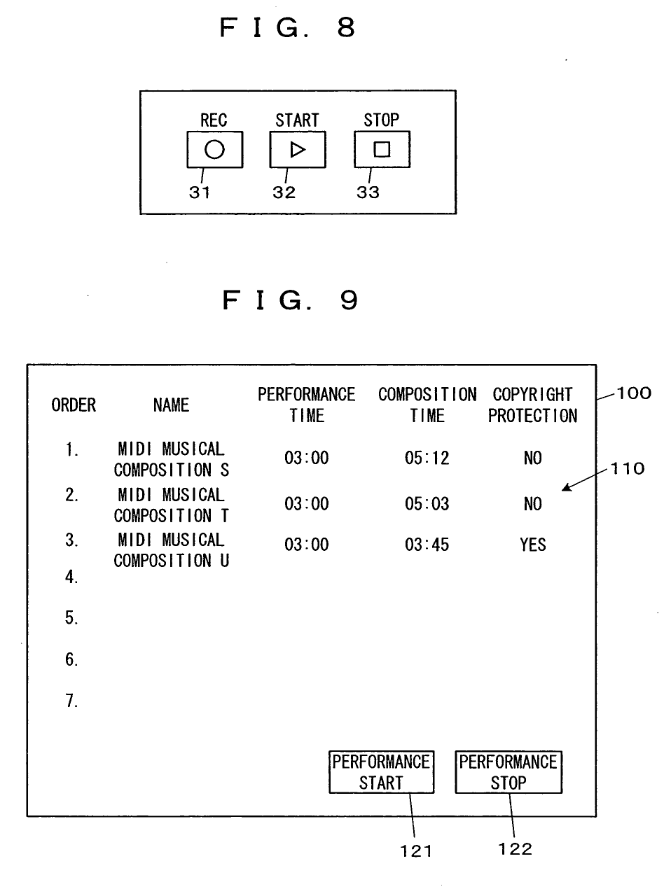

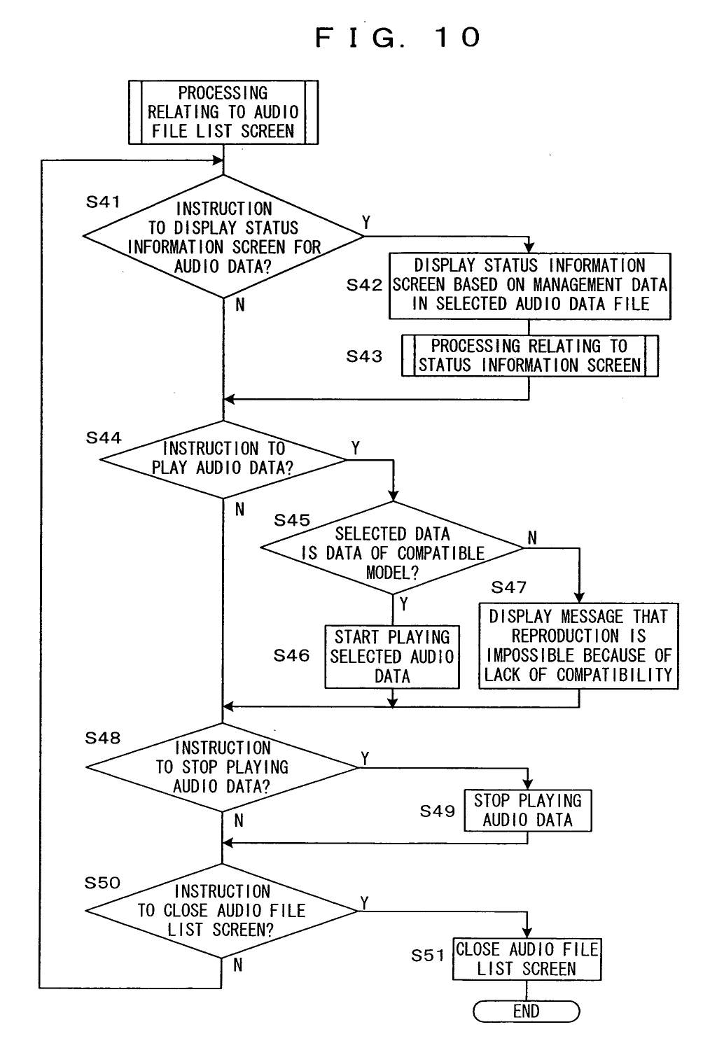

This processing includes processing of accepting an instruction to start or stop recording the audio data (sound recording) onto the HDD 16 through controls as shown in FIG. 8 provided on a control panel, and processing of accepting an instruction to set the automatic performance list showing musical compositions subjected to automatic performance and to start and stop the automatic performance by means of a performance list screen 100 as shown in FIG. 9 displayed by the display device 23.

For example, the controls shown in FIG. 8 toggles setting and release of the state of waiting recording when a sound recording button 31 is pressed, starts recording when a start button 32 is pressed in the state of waiting recording, and stops the recording when a stop button 33 is pressed. The start/stop of the sound recording can also be cooperated with start/stop of the automatic performance based on the MIDI musical composition data or performance by the performance control 21.

As for the screen shown in FIG. 9, when the user selects a “name” box of an automatic performance list display section 110, a not-shown MIDI musical composition data selection screen is displayed by the display device 23 to accept selection of MIDI musical composition data. The MIDI musical composition data selected by the user on the screen is set as the data to be used for automatic performance, and its file name and/or musical composition name are/is displayed in the “name” box. Further, from the management data in the selected MIDI musical composition data, the information on performance time and copyright flag of the musical composition are obtained, basing on which contents of items “composition time” and “copyright protection” are displayed. Although the same value as that of the “composition time” is set in the “performance time” as a default value in this event, this value can be changed in accordance with an instruction of the user. FIG. 9 shows the state in which the MIDI musical composition data for three compositions are set as objects to be subjected to automatic performance by the above-described operation.

When a performance start button 121 is pressed, the CPU 11 sequentially executes automatic performance only for periods of time designated in the box of the “performance time” based on each piece of MIDI musical composition data in accordance with the contents set in the automatic performance list display section 110 at that point in time. When a performance stop button 122 is pressed during execution of the automatic performance, the automatic performance is stopped.

When the audio data generated by the automatic performance is recorded on the HDD 16, the automatic performance list set on the performance list screen 100 is recorded in the management data corresponding to the audio data.

Return to the description of FIG. 5.

After step S12, the CPU 11, when it is executing automatic performance, carries out processing relating to the automatic performance in accordance with the performance list set on the performance list screen 100 (S13, S14). The CPU 11, when it is executing sound recording onto the HDD 16, carries out processing relating to sound recording (S15, S16). When stopping the sound recording, the CPU 11 generates management data and stores, into the HDD 16, an audio data file in the restriction format containing the management data and the recorded audio data (S17 to S20). Details of the processing are as described using FIG. 4, and therefore their description will be omitted. In the processing in steps S18 to S20, the CPU 11 functions as a first controller.

The audio data LR1 recorded in step S16 may be either data generated by the sound source 20 in step S14 or data generated by the sound source 20 according to the operation of the performance controls 21 in step S12. If no audio data is sent from the signal processor 24, data representing no sound will be recorded.

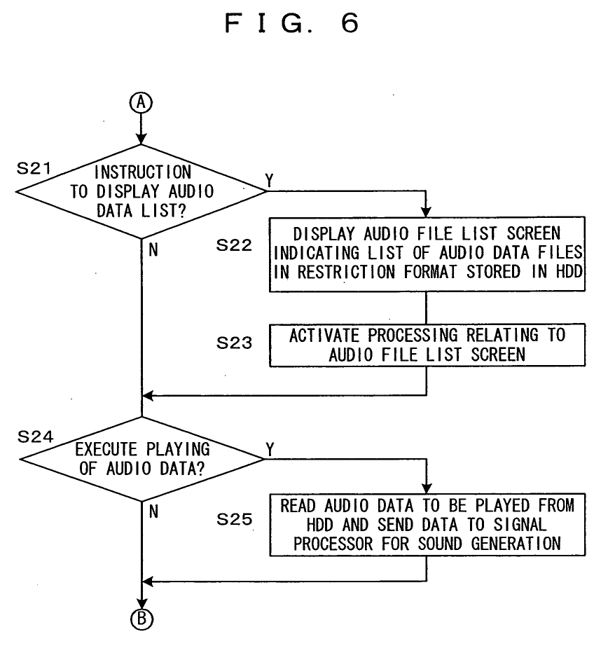

In the case of NO in step S15 or S17 or after step 20, the processing proceeds to step S21 in FIG. 6.

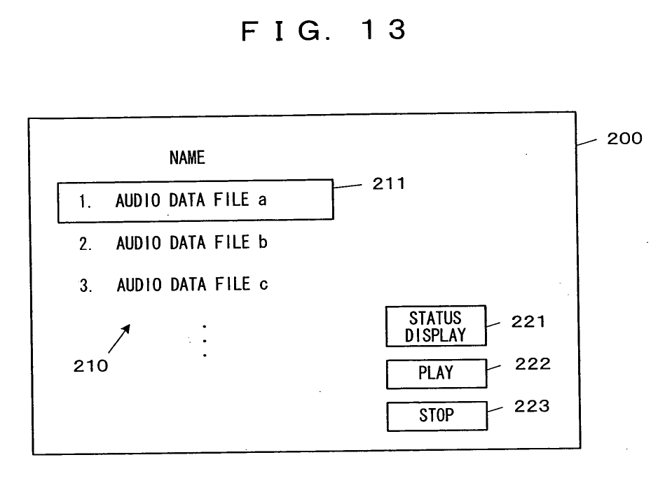

If there is an instruction to display an audio data list here, the CPU 11 causes the display device 23 to display an audio file list screen as shown in FIG. 13 indicating a list of audio data files in the restriction format stored in the HDD 16, and activates processing relating to the screen (S21 to S23). The processing relating to the audio file list screen is as shown in FIG. 10, whose contents will be described later. The audio file list screen may be a screen indicating a list of files in a designated directory.

On the other hand, in the case of NO in step S21 or after step S23, the processing in the main flow proceeds to step S24, in which the CPU 11, when it is executing play of the audio data, reads the audio data to be played from the HDD 16 and sends the data to the signal processor 24, which is outputted to the speaker 26 for sound generation based on the audio data.

Thereafter, the processing proceeds to step S26 in FIG. 7, and if there is an instruction to convert the audio data file to a general format, the CPU 11 carries out processing relating to conversion (S27 to S29). This processing is for creating an audio data file in the general format in the WAV format or the like from the audio data file in the restriction format which is instructed to convert when the protection flag in the instructed audio data file is “0” indicating no restriction of copy and movement (S28), and otherwise displaying a warning message to the user without conversion (S29). In other words, conversion of audio data to the general format is inhibited as regards one with a protection flag indicating inhibition of copy and movement.

In the processing in steps S27 to S29, the CPU 11 functions as a third controller. In the processing in step S28, the CPU 11 functions as a converter.

In the electronic musical instrument 10, the function of converting to the general format is provided to allow the recorded audio data to be widely used by common devices for enhanced convenience. On the other hand, conversion to the general format is inhibited for the data whose copy and movement need to be inhibited for reasons of copyright protection and so on, to prevent the data from becoming readable for use by other devices.

It is also conceivable that the audio data file in the general format cannot contain the management data depending on request on the format, and in this case it is acceptable to leave only the portion of the audio data in the file. It is also conceivable to prepare a text file having the same file name and describe contents of the management data or the like in the file so as to separately refer to contents of the audio data and the contents of the management data. Depending on the data configuration of the restriction format, the audio data can be converted to the general format only by taking out the portion of the audio data without processing it.

In the case of NO in step S26, or after step S28 or S29, the processing proceeds to step S30. If there is an instruction to copy or move the audio data file, the CPU 11 carries out processing relating to copy or movement (S31 to S33). This processing is for copying or moving the audio data file which is instructed to copy or move to a designated transfer destination as it is in the restriction format when the protection flag in the instructed audio data file is “0” indicating no restriction of copy and movement (S32), and otherwise displaying a warning alarm message to the user without copy and movement (S33). In other words, copy and movement are permitted or inhibited basing on the contents of the protection flag.

In the processing in steps S31 to S33, the CPU 11 functions as a first controller.

The contents of the audio data file in the use restriction format cannot be normally read by common devices, but devices which are of the same type or devices having a format conversion function (PCs with dedicated player software installed thereon and the like) can use the contents. Hence, in the electronic musical instrument 10, copy and movement of data, whose copy and movement do not need to be inhibited, are made possible so as to allow the data to be used in other devices for enhanced convenience, while copy and movement of data whose copy and movement need to be inhibited for reasons of copyright protection and so on are inhibited so as to prevent the data from being usable in other devices.

For inhibition of copy and movement, it is sufficient to inhibit means to enable use of data in external devices, such as copy and movement to a removable recording medium, transmission to external devices via the external device I/F 15 or the like. Thus, it is not essential to inhibit copy and movement for data reduction inside the electronic musical instrument 10.

Thereafter, if there is an instruction to end the operation of the electronic musical instrument 10, the CPU 11 ends the processing in step S34, and otherwise returns to step S 12 in FIG. 5 to repeat the processing.

Next, using FIG. 10 to FIG. 15, processing relating to the audio file list screen, processing relating thereto, and contents of the screen will be described. Although the processing described here is shown in flowcharts separate from that of the main processing shown in FIG. 5 to FIG. 7, such a configuration is not essential, and the processing described here can also be incorporated in the main processing. 5 First of all, a display example of the audio data file list screen is shown in FIG. 13.

The audio data file list screen 200 is a screen displayed by the display device 23 in the above-described step S22 in FIG. 6, and on this screen the list of the audio data files in the use restriction format stored in the HDD 16 is displayed within a file list display section 210. A status display button 221 accepts an instruction to display a status information display screen that displays the contents of the environment information and the protection flag in the management data for (the audio data corresponding to) the audio data file selected by a cursor 211. Further, a play button 222 and stop button 223 accept an instruction to play and to stop playing of the audio data for the audio data file selected by the cursor 211.

Next, a flowchart of processing relating to the audio file list screen is shown in FIG. 10.

In this processing, when there is an instruction to display the status information screen for the audio data, the CPU 11 first displays the status information screen based on the management data in the selected audio data file, and carries out processing relating to the status information screen (S41 to S43). This screen and the contents of the processing will be described later.

When there is an instruction to play the audio data, the CPU 11 carries out processing relating to play of the data (S44 to S47). In this processing, if the selected data is data of a compatible model, the CPU 11 starts playing the audio data (S46), and otherwise causes the display device 23 to display a warning message and does not start playing (S47). This determination can be made basing on the information on the electronic musical instrument kind in the management data and information relating to a range of compatibility as described later. Further, the processing of playing itself is carried out in step S25 in FIG. 6.

When there is an instruction to stop playing the audio data, the CPU 11 carries out processing to stop playing the audio data (S48, S49).

When there is an instruction to close the audio file list screen 200, the CPU 11 closes the audio file list screen 200 and end the processing (S50, S51), and otherwise returns from step S50 to step S41 to repeat the processing.

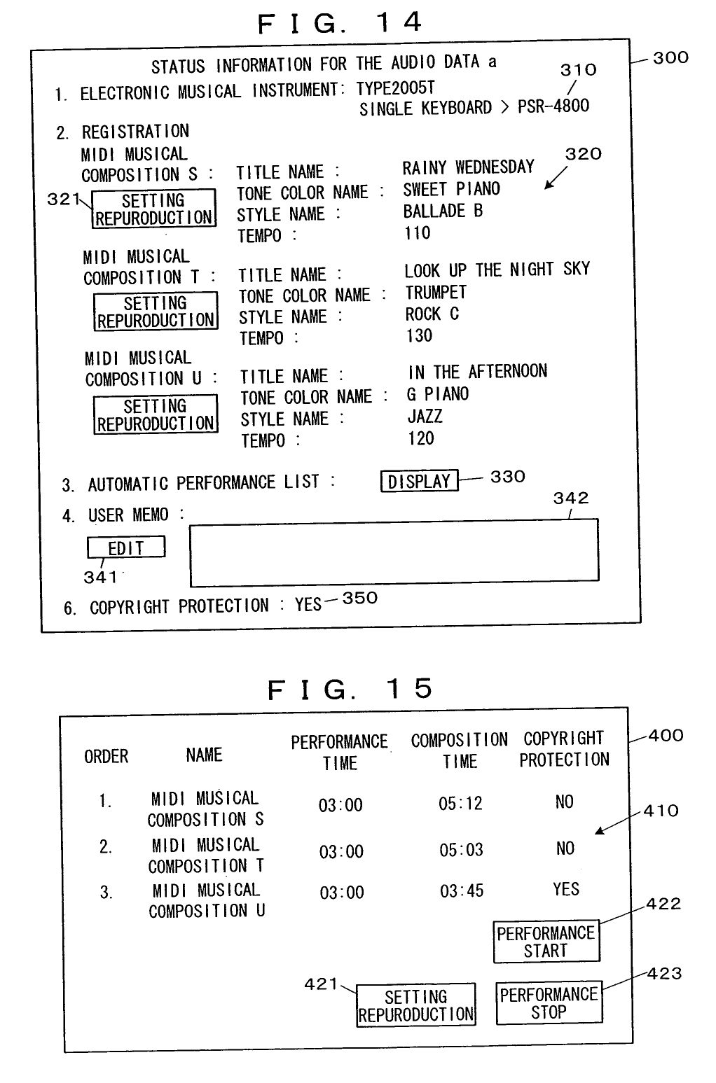

Next, a display example of a status information screen will be shown in FIG. 14.

The status information screen 300 is a screen displayed by the display device 23 in the above-described processing in step S42 in FIG. 10 and displays contents of the environment information and the protection flag as status information for the audio data file selected on the audio file list screen 200. In other words, this is a screen to present information relating to the generation environment of the audio data to the user.

Further, the model of the electronic musical instrument which has generated the audio data is displayed basing on the information of the “electronic musical instrument kind” within a device kind display section 310, setting contents of the electronic musical instrument 10 at the time of generating the audio data are displayed for each musical composition basing on the information of the “registration” within a registration display section 320, and whether or not to restrict copy and movement of the audio data (displayed as the presence or absence of copyright protection here) is displayed basing on the information of the “protection flag” within a protection setting display section 350. For the model of the electronic musical instrument, the range of compatibility of the audio data is displayed on the left side of “>” and a concrete model name is display on the right side.

The automatic performance list can be displayed by opening a later-described performance list reference screen upon instruction of pressing a display button 330. User memo is displayed within a user memo display section 342 which is initially blank and can be shifted to an edit mode by a press of an edit button 341 to edit the user memo.

Further, it is also possible to change the setting of the electronic musical instrument 10 according to the contents displayed on the status information screen 300, in which a reproduction setting button 321 can be pressed to instruct reproduction of setting so as to set the contents of the registration relating to the corresponding musical composition in the sound source 20 and so on to reflect the contents on the operation of the electronic musical instrument 10, thereby reproducing the environment at the time of generating the audio data.

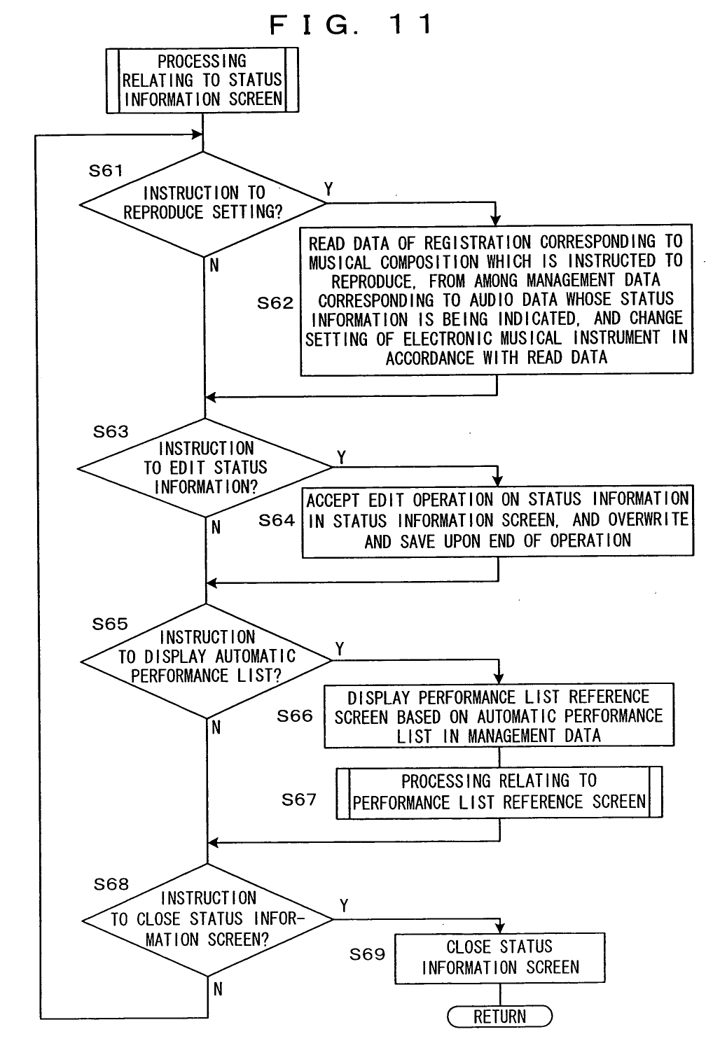

Next, a flowchart of processing relating to the status information screen 300 is shown in FIG. 11.

In this processing, when there is an instruction to reproduce setting, the CPU 11 first reads the data of the registration corresponding to the musical composition which is instructed to reproduce, from the management data corresponding to the audio data indicating the status information, and changes the setting of the electronic musical instrument 10 in accordance with the read data (S61, S62). The CPU 11 carries out such processing while recording the setting contents as the registration at the time of recording the audio data, thereby making it possible to easily reproduce the environment at the time of generating the audio data basing on the information contained in the audio data file, so that the user can utilize the data when carrying out performance or practicing the musical composition in the environment similar to that of the musical composition relating to the audio data, resulting in enhanced convenience of the electronic musical instrument.

When there is an instruction to edit the status information, the CPU 11 accepts an edit operation on the status information being displayed on the status information screen 300, and overwrites and saves the management data upon end of the operation (S63, S64). Note that only the user memo can be edited here.

When there is an instruction to display the automatic performance list, the CPU 11 displays the performance list reference screen based on the automatic performance list in the management data corresponding to the audio data whose status information is displayed, and carries out processing relating to the performance list reference screen (S65 to S67). This screen and contents of the processing will be described later.

When there is an instruction to close the status information screen 300, the CPU 11 closes the status information screen 300 in step S69 and returns to the processing relating to the audio file list screen 200, and otherwise returns to step S68 to repeat the processing.

Next, a display example of the performance list reference screen will be shown in FIG. 15.

The performance list reference screen 400 is a screen displayed by the display device 23 in the above-described processing in step S66 in FIG. 11, and displays, within a musical composition information display section 410, the contents of the automatic performance list in the environment information for the audio data file selected on the audio file list screen 200. Although this display form is similar to that in the case of the performance list screen 100 shown in FIG. 9, contents displayed here are the automatic performance list relating to the automatic performance which was carried out before. Accordingly, it is conceivable that the MIDI musical composition data file being displayed no longer exists within the range available by the electronic musical instrument 10. It is preferable, in such a case, to display the data file distinguishable by color, font, half-tone dot meshing, or the like in order to indicate its absence.

The screen is configured such that a reproduction button 421 can be pressed to instruct to reproduce the automatic performance list so as to set the automatic performance list being displayed on the performance list reference screen 400 as the list for automatic performance executed by the electronic musical instrument 10, thereby reproducing the setting of the automatic performance list at the time of generating the audio data. Further, a performance start button 422 can be pressed to instruct to start automatic performance in addition to the above-described reproduction of automatic performance list, thereby executing automatic performance based on the automatic performance list being displayed on the performance list reference screen. Further, a performance stop button 423 can be pressed to instruct to stop the automatic performance.

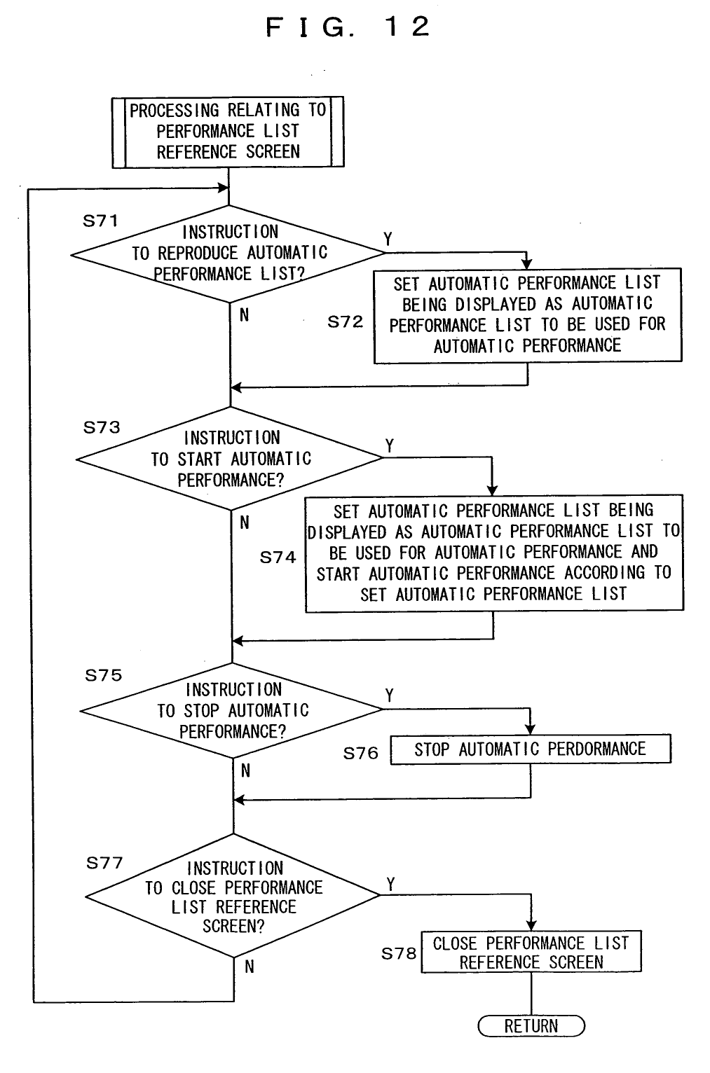

Next, a flowchart of processing relating to the performance list reference screen 400 is shown in FIG. 12.

In this processing, when there is an instruction to reproduce the automatic performance list, the CPU 11 sets the automatic performance list being displayed within the performance list reference screen 400 as the automatic performance list to be used for automatic performance (S71, S72). The CPU 11 then may shift the screen to the performance list screen 100 as shown in FIG. 9, thereby allowing the automatic performance list to be edited. Such a configuration allows the electronic musical instrument 10 to execute automatic performance in accordance with the automatic performance list after edit and to record again audio data generated as a result of the automatic performance, thereby easily creating audio data which is changed in the order of compositions or in performance period basing on the audio data which has been recorded before.

When there is an instruction to start automatic performance, the CPU 11 sets the automatic performance list as described above and additionally starts automatic performance based on the set automatic performance list (S73, S74). Carrying out such processing makes it possible that even in the case where the CPU 11 cannot reproduce the audio data because of, for example, difference in format of the audio data or the like, if the base MIDI musical composition data is stored, the CPU 11 can reproduce the musical composition of the same contents. Note that the processing of automatic performance itself is carried out in step S14 in FIG. 5. If MIDI musical composition data unavailable by the electronic musical instrument 10 is contained in the automatic performance list, the CPU 11 can cope with that situation by carrying out automatic performance skipping that MIDI musical composition data, regarding it as an error and carrying out no automatic performance, or the like.

When there is an instruction to stop automatic performance, the CPU 11 stops the automatic performance (S75, S76).

When there is an instruction to close the performance list reference screen 400, the CPU 11 closes the performance list reference screen 400 and returns to the processing relating to the status information screen 300 (S77, S78), and otherwise returns from step S77 to step S71 to repeat the processing.

The electronic musical instrument 10 can carry out the processing as has been described above to realize operation relating to characteristics of this embodiment such as restriction of copy and movement in accordance with necessity for each piece of data and presentation of the environment at the time of generating the audio data to the user.

This is the end of the description of the embodiment but, as a matter of course, the configuration of the apparatus, the concrete processing contents, the operation method, and so on are not limited to those described in the above-described embodiment.

Although an example using the copyright flag or protection flag representing the information indicating the presence or absence of use restriction of data in two values, for example, has been described in the above-described embodiment, other information, for example, the name of copyright holder, the registered number of right, and so on may also be recorded. Further, the contents of the copyright flag and protection flag may be used for applications other than the above-described one. For example, the contents may be used also for permission or inhibition of output of the MIDI data to the external part.

Further, for the MIDI data, it is not essential to indicate the information indicating whether or not to restrict use as an explicit flag or the like. For example, it is possible to cause the following data to be determined as data whose use should be restricted even without explicit information: data configured such that it cannot be read and copied by ordinary PCs or MIDI sequencers of other manufactures, such as musical composition data stored in a flexible disk formatted in the original form of a manufacturer, data stored on a recording medium in an encrypted state, data downloaded by a user in an encrypted state, and so on.

As a matter of course, the reason for use restriction of data is not limited to copyright protection. For example, the reason may be patent protection or may be charge or the like irrelevant to right protection.

It is also conceivable that a format capable of embedding a digital electronic watermark in audio data is employed in the audio data file so that information corresponding to the management data is recorded in the digital electronic watermark.

Further, it is, of course, possible to apply the invention to electronic musical apparatuses other than the electronic musical instrument, for example, to any electronic musical apparatus such as a hard disk recorder, a MIDI sequencer, a digital mixer, a karaoke apparatus, a PC capable of executing software to process the musical composition data and the audio data. The format of data used for the automatic performance or the performance by the performance controls is not limited to the MIDI format. Any format under any standard may be employed as long as it expresses each music sound of a musical composition by data such as ON/OFF of note, timing, velocity or the like.

The memory that stores the musical composition data and the audio data is not limited to one incorporated in the electronic musical apparatus, but may be a removable recording medium, a recording device provided external to the apparatus, a recording medium mounted on the recording device, and the like.

Further, the program of the invention is a program for causing a computer to control hardware so as to control the electronic musical apparatus as described above, and previously stored in the ROM, the HDD, or the like. The same effect can be obtained even by providing the program recorded on a non-volatile recording medium (memory) such as a CD-ROM or a flexible disk so that the program is read from the memory into the RAM and executed by the CPU, or by downloading the program from an external device incorporating a recording medium with the program recorded thereon or from an external device with the program stored in a memory such as an HDD or the like.

As has been described, according to the electronic musical apparatus or the program of the invention, in an electronic musical apparatus having a sound recording function of recording audio data generated basing on MIDI data, copy and movement can be restricted for the audio data generated basing on the MIDI data if it requires restriction.

Accordingly, an electronic musical apparatus can be provided which is capable of restricting use of the audio data by a user when necessary.

What is claimed is:

1. An electronic musical apparatus, comprising:
an audio data generator for generating audio data corresponding to MIDI data basing on the MIDI data;
a memory;
a first controller for generating, when the audio data generated by said audio data generator is stored in said memory, data of a protection flag indicating whether or not to inhibit copy and movement of the audio data basing on contents of the MIDI data used for generation of the audio data, and storing the data of the protection flag together with the audio data in said memory; and
a second controller for permitting or inhibiting copy and movement of the audio data stored in said memory basing on contents of the protection flag.

2. An electronic musical apparatus according to claim 1, wherein
said first controller stores the audio data and the protection flag in said memory in a restriction format, the restriction format preventing a common device from normally reading the audio data and protection flag.

3. An electronic musical apparatus according to claim 2, further comprising:
a converter for converting the audio data stored in said memory in the restriction format to a predetermined format, the predetermined format allowing the common device to normally read the audio data; and
a third controller for inhibiting conversion by said converter for the audio data whose protection flag indicates inhibition of copy and movement thereof.

4. An electronic musical apparatus according to claim 1,
wherein said audio data generator includes a generator for generating one piece of audio data corresponding to a plurality of pieces of MIDI musical composition data basing on the plurality of pieces of MIDI musical composition data, and
wherein said first controller makes the data of the protection flag data indicating inhibition of copy and movement of the audio data for the audio data corresponding to the plurality of pieces of MIDI musical composition data, when at least one piece of the corresponding MIDI musical composition data contains information that use of the data is restricted.

5. An electronic musical apparatus according to claim 2,
wherein said audio data generator includes a generator for generating one piece of audio data corresponding to a plurality of pieces of MIDI musical composition data basing on the plurality of pieces of MIDI musical composition data, and
wherein said first controller makes the data of the protection flag data indicating inhibition of copy and movement of the audio data for the audio data corresponding to the plurality of pieces of MIDI musical composition data, when at least one piece of the corresponding MIDI musical composition data contains information that use of the data is restricted.

6. An electronic musical apparatus according to claim 3,
wherein said audio data generator includes a generator for generating one piece of audio data corresponding to a plurality of pieces of MIDI musical composition data basing on the plurality of pieces of MIDI musical composition data, and
wherein said first controller makes the data of the protection flag data indicating inhibition of copy and movement of the audio data for the audio data corresponding to the plurality of pieces of MIDI musical composition data, when at least one piece of the corresponding MIDI musical composition data contains information that use of the data is restricted.

7. A computer program containing program instructions executable by a computer which controls an electronic musical apparatus, and causing said computer to execute:
an audio data generating process of generating audio data corresponding to MIDI data basing on the MIDI data;
a first controlling process of generating, when the audio data generated in said audio data generating process is stored in a memory, data of a protection flag indicating whether or not to inhibit copy and movement of the audio data basing on contents of the MIDI data used for generation of the audio data, and storing the data of the protection flag together with the audio data in the memory; and
a second controlling process of permitting or inhibiting copy and movement of the audio data stored in the memory basing on contents of the protection flag.
